(19) United States
(12) Patent Application Publication
(10) Pub. No.: US 2015/0092903 A1
(43) Pub. Date: Apr. 2, 2015

(54) Method and container packaging and transporting irradiated control rod blades

(71) Applicant: WMG, Inc., Peekskill, NY (US)

(72) Inventors: Peter Tuite, Peekskill, NY (US); Kevin Tuite, Peekskill, NY (US)

(73) Assignee: WMG, Inc., Peekskill, NY (US)

(21) Appl. No.: 13/998,102

(22) Filed: Sep. 30, 2013

(51) Int. Cl. G21F 5/015; G21F 5/14; G21C 19/32

(52) U.S. Cl. CPC G21F 5/015; G21C 19/32; G21F 5/14
USPC 376/272

(57) ABSTRACT

A container for storing intact control rod blades including a cask which has a substantially square elongated portion and axially opposed dual end closures, such that the substantially square elongated portion is capable of receiving a basket containing a plurality of control rod blades, where each of the control rod blades has a cruciform end and a velocity limiter end, so that the cruciform end of one control rod blade rests against the velocity limiter end of an adjacent control rod blade, and where the substantially square elongated portion of the cask is comprised of three layers, an inner layer, a middle layer and an outer layer, with the inner and outer layers made of ASTM A543 Steel.

### FIELD OF THE INVENTION

The invention relates to a method and a container for packaging and transporting for disposal intact irradiated control rod blades that are generated at commercial nuclear power plants.

### BACKGROUND INFORMATION

In the United States, over 100 nuclear reactors supply about 20% of the electricity needed to power consumer demand, and worldwide, over 400 reactors provide 17% of the world's electricity. Among the radioactive materials found at nuclear power plants are enriched uranium, low-level waste, and spent nuclear fuel. Low-level radioactive waste includes items that have become contaminated with radioactive material. This waste typically consists of contaminated protective shoe covers and clothing, wiping rags, mops, filters, reactor water treatment residues, and equipment and tools. Low-level waste is stored at the nuclear power plant until either the radioactivity in the waste decays away or there is enough waste for shipment to a low-level waste disposal site.

Controls Rod Blades (CRBs) represent a relatively high level source of low level radioactive waste that must either be stored or disposed of properly. Most irradiated reactor components, including CRBs, generated at reactors require processing for size reduction due to the available transportation casks not being physically capable of containing unprocessed material. A typical CRB, is 175″ in total length and has an upper and a lower section. The upper section is 150″ long, having a cruciform. The cruciform is 9.88″ across and has blade sections that are 0.33″ thick. The lower section, known as the velocity limiter, is 20″ long and has a round cross section at its top and bottom 9.2″ in diameter.

Because of the way they are used in operation, the discharged CRBs have radiation levels that vary significantly from their top to bottom sections, with the radiation level at the top of the cruciform section being as high as 20,000 R/hr and the radiation level at the bottom of the limiter section being a low as 50 R/hr.

Currently, due to the length of the CRBs, commercial nuclear power plants process the irradiated CRBs using a crushing and shearing technique in order to facilitate their transport in an accident resistant cask to the site of disposal. Processing operations for this extremely high activity metal represents a significant source of risk, cost and radiation exposure for the nuclear utilities.

In addition, although it is posited that CRBs can be packaged in large casks designed for spent fuel transportation, such casks would be very large and heavy and would require transportation by railroad. Furthermore, most nuclear power plants lack the infrastructure to handle large rail casks and disposal sites cannot accept rail casks, thus, necessitating the design and fabrication of the cask of the present invention.

The present invention relates to a method and a container for packaging and transporting for disposal of intact irradiated CRBs that are generated at commercial nuclear power plants.

### PRIOR ART

IAEA Publication of April 1999 entitled Spent Fuel Storage and transport Cask Decontamination and Modification discloses a cask with dual impact limiters and an inner basket. However, the present invention is directed towards casks for irradiated hardware transportation.

NPL Reference dated Oct. 22, 2012 entitled Typical Spent Fuel Transportation discloses a typical spent fuel cask having dual closures. The present invention is directed towards casks for irradiated hardware shipping and transport.

EP0758130A1 discloses a method of storing control rod blades including a nesting configuration. However, that method is not directed towards packaging for transportation, unlike the present invention.

SUMMARY OF THE PRESENT INVENTION

The present invention relates to a method and a container for packaging and transporting for disposal irradiated CRBs that are generated at commercial nuclear power plants.

Specifically, there is disclosed in the present invention a container for storing intact control rod blades including a cask which has a substantially square elongated portion and axially opposed dual end closures, such that the substantially square elongated portion is capable of receiving a basket containing a plurality of control rod blades, where each of the control rod blades has a cruciform end and a velocity limiter end, so that the cruciform end of one control rod blade rests against the velocity limiter end of an adjacent control rod blade, and where the substantially square elongated portion of the cask is comprised of three layers, an inner layer, a middle layer and an outer layer, with the inner and outer layers made of ASTM A543 Steel.

Furthermore, there is disclosed in the present invention, a container for storing intact control rod blades having a basket which includes two axially opposed ends, with the first axially opposed end of the basket being removable, and fitted with a lifting device attachment, and another axially opposed end including bars emanating in a direction parallel to a rod which spans a length from the first axially opposed end to the other axially opposed end, with the bars spanning a length from the axially opposed end to an approximately midway point of the length of the rod, the bars being secured by a substantially square cross sectioned ring to which they are integrally connected.

Moreover, there is disclosed in the present invention, a method of transporting intact control rod blades, comprising placing control rod blades within a basket, wherein adjacent control rod blades are configured such that a cruciform end of one control rod blade rests against a velocity limiter end of an adjacent control rod blade, placing the basket within a cask, the cask having a substantially square elongated portion and axially opposed dual end closures, the substantially square elongated portion being capable of receiving the basket containing a plurality of control rod blades, and wherein the substantially square elongated portion of the cask is comprised of three layers, an inner layer, a middle layer and an outer layer, the inner and outer layers being comprised of ASTM A543 Steel.

### BRIEF DESCRIPTION OF THE DRAWINGS

FIG. 1 is the transportation cask of the present invention;

FIG. 1A is a schematic of the components cask of the present invention;

FIG. 2 is a cross section of the transportation cask of the present invention;

FIG. 2A is a longitudinal section view of the elongated portion of the transportation cask of the present invention;

FIG. 3 is a longitudinal section view of the storage/shipping basket of the present invention when empty;

FIG. 4 is a longitudinal section view of the nesting configuration of the CRBs in the basket of the present invention;

FIG. 5 is a top cross section view of the nesting configuration of the present invention;

FIG. 6 is a longitudinal section view of the empty storage/shipping liner of the present invention;

FIG. 7 is a longitudinal section view of the storage/shipping basket of the present invention as loaded;

### DETAILED DESCRIPTION OF THE PREFERRED EMBODIMENT

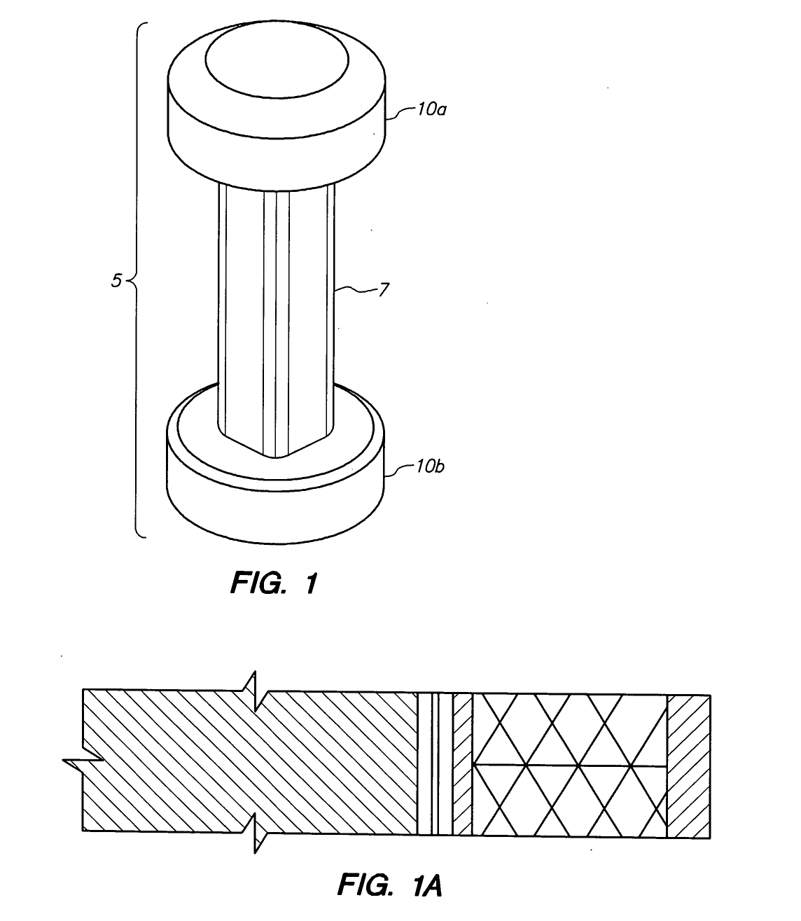

With reference now to FIG. 1, the transportation cask 5 of the present invention generally comprises an elongated portion 7 with dual closures 10 a,b at axially opposed ends of the elongated structure 7 to enable loading and unloading from either closure 10 a,b, thereby providing operational flexibility for loading and, further, allowing the cask to be used as a transfer shield for disposal.

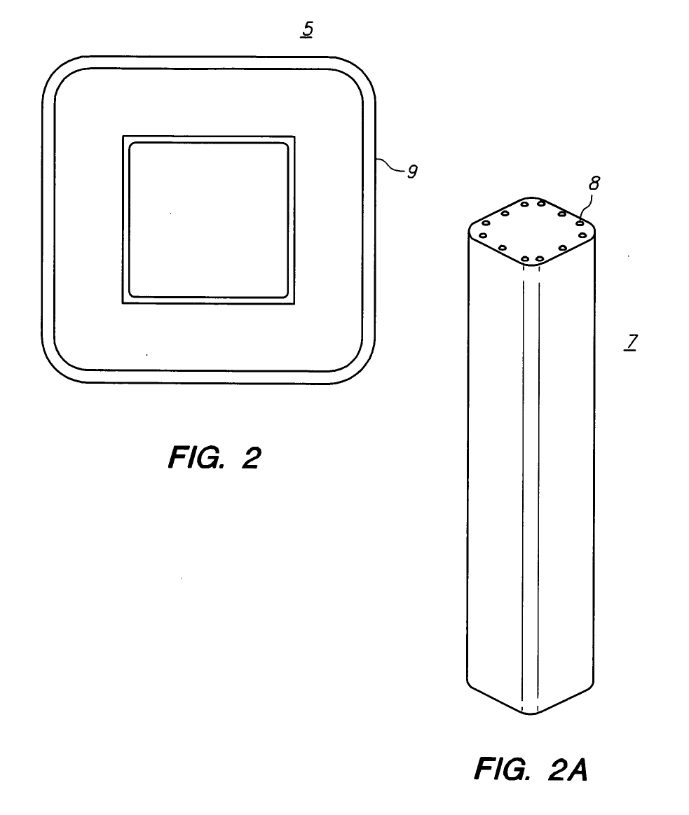

As depicted in FIG. 2, the elongated portion 7 is of a substantially square cross-section 9. As shown in FIG. 2A, each of the ends of the elongated portion 7 include spaced circular protuberances 8 which fit into cavities in the dual closures 10 a,b.

The shielding aspect of the cask utilizes ASTM A543 Steel (AKA HY-80 Steel) in a traditional steel-lead-steel configuration, however, the use of the ASTM A543 Steel, which was originally fabricated for use in submarine hulls, makes it possible for the cask to meet hypothetical accident conditions while meeting weight constraints for road transportation. As is depicted in FIG. 1A, the inner steel thickness of the cask of the present invention is able to be minimized to 0.75″, the lead thickness is 5.5″, and the outer steel thickness is minimized to 1.5″. The external dimensions of the cask are 270″×96″, while the internal dimensions for the cask cavity are 192″×26.5″. The cask 5 is capable of transporting eight intact Control Rod Blades (CRBs), with a gross weight of 80,000 lbs.

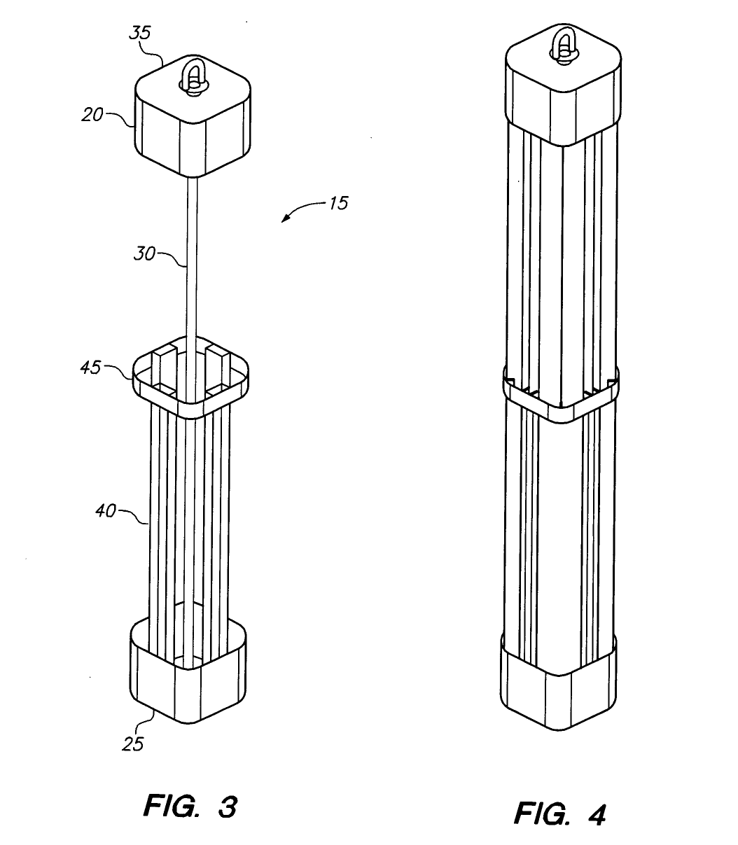

With reference to FIG. 3, there is depicted the shipping/storage basket 15 of the present invention, for containing intact CRBs. The basket 15 has two axially opposite ends 20, 25 of a substantially square cross-section and a rod 30 spanning between the two ends that defines the length of the basket, which is specifically long enough to accommodate a typical CRB. A removable end 20 of the basket is fitted with a lifting device attachment 35 to enable hanging of the basket. The opposite end 25 of the basket includes bars 40 emanating in a direction parallel to the rod 30 from each side of the square cross section to an approximately midway point of the length of the rod 30. Securing the bars is a substantially square cross sectioned ring 45 to which the bars 40 are integrally connected.

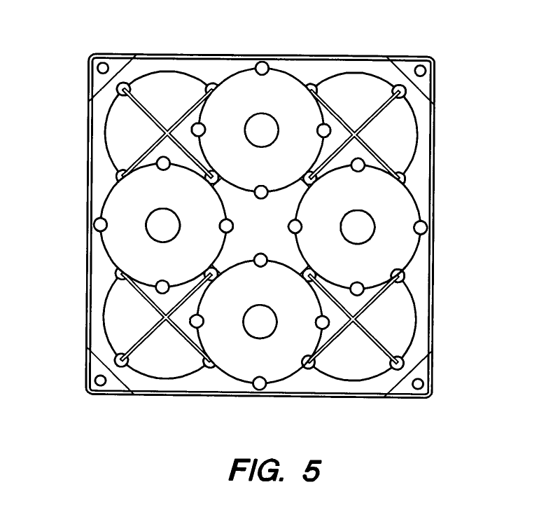

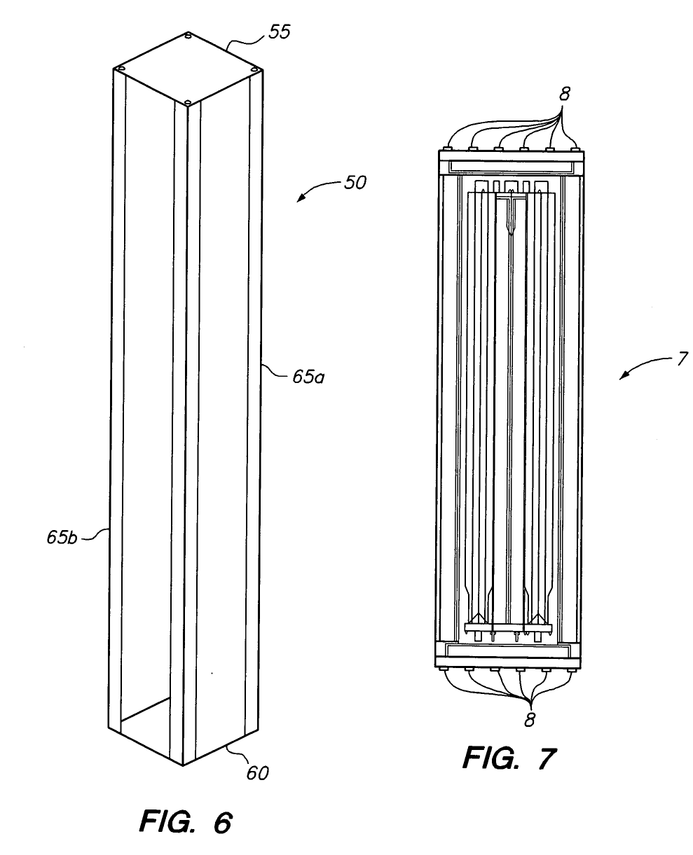

Thus, the end 25, bars 40 and ring 45 define the basket aspect of the present invention. In use, the basket 15 is loaded remotely one CRB at a time. The first four CRBs have the velocity limiter towards end 25 and the next four CRBs have the velocity limiter towards end 20, as depicted in FIGS. 4 and 5. Thus, the basket 15 of the present invention accommodates eight intact CRBs in a head to toe nesting configuration. Due to the axial variation in radiation level, the storage of the CRBs in such a fashion achieves a more uniform dose rate on the exterior packaging, and also optimizes packaging efficiency and shielding. With reference to FIGS. 6 and 7, there is depicted the storage/shipping liner 50 of the present invention. The liner 50 is a box like structure with axially opposed end walls 55,60 and four side walls 65 a,b,c,d. Similar to the basket 15 of the present invention, the CRBs are loaded into the liner 50 in a head to toe nesting configuration, as depicted in FIG. 7. In an alternate configuration, the basket 15 of the present invention may be loaded into the liner 50 of the present invention.

1. A container for storing intact control rod blades comprising a cask, said cask having a substantially square elongated portion and axially opposed dual end closures, said substantially square elongated portion being capable of receiving a basket containing a plurality of control rod blades, each of said control rod blades having a cruciform end and a velocity limiter end, wherein the cruciform end of one control rod blade rests against the velocity limiter end of an adjacent control rod blade, and wherein the substantially square elongated portion of said cask is comprised of three layers, an inner layer, a middle layer and an outer layer.

2. The container as in claim 1, wherein said inner and outer layers of the substantially square elongated portion of said cask are comprised of ASTM A543 Steel.

3. The container as in claim 1, wherein said basket includes two axially opposed ends, wherein a first axially opposed end of said basket is removable, and wherein said first axially opposed end is fitted with a lifting device attachment, and wherein another axially opposed end includes bars emanating in a direction parallel to a rod which spans a length from the first axially opposed end to another axially opposed end, and wherein the bars span a length from the axially opposed end to an approximately midway point of the length of the rod, and wherein the bars are secured by a substantially square cross sectioned ring to which they are integrally connected.

4. A method of transporting intact control rod blades, comprising placing said control rod blades within a basket, wherein adjacent control rod blades are configured such that a cruciform end of one control rod blade rests against a velocity limiter end of an adjacent control rod blade, placing said basket within a cask, said cask having a substantially square elongated portion and axially opposed dual end closures, said substantially square elongated portion being capable of receiving said basket containing a plurality of control rod blades, and wherein the substantially square elongated portion of said cask is comprised of three layers, an inner layer, a middle layer and an outer layer.

5. The method of claim 4, wherein said inner and outer layers of the substantially square elongated portion of said cask are comprised of ASTM A543 Steel.

6. A method of transporting intact control rod blades, comprising placing said control rod blades within a basket, wherein adjacent control rod blades are configured such that the cruciform end of one control rod blade rests against the velocity limiter end of an adjacent control rod blade, placing said basket within a cask, said cask having a substantially square elongated section and axially opposed dual end closures, said substantially square elongated section being capable of receiving said basket containing a plurality of control rod blades.

7. The method according to claim 6, wherein the substantially square elongated section of said cask is comprised of three layers, an inner layer, a middle layer and an outer layers.

8. The method according to claim 7, wherein said inner and outer layers of the substantially square elongated portion of said cask are comprised of ASTM A543 Steel.
